(19) United States
(12) Patent Application Publication
(10) Pub. No.: US 2021/0185497 A1
(43) Pub. Date: Jun. 17, 2021

(54) CONTROL DEVICE AND VEHICLE

(71) Applicant: Isuzu Motors Limited, Tokyo (JP)

(72) Inventor: Yasuyuki MISHIMA, Fujisawa-shi, Kanagawa (JP)

(73) Assignee: Isuzu Motors Limited, Tokyo (JP)

(21) Appl. No.: 17/271,630

(22) PCT Filed: Aug. 30, 2019
(86) PCT No.: PCT/JP2019/034278

§ 371 Date: Feb. 26, 2021

(30) Foreign Application Priority Data
Aug. 31, 2018 (JP) 2018-163362

(51) Int. Cl. H04W 4/46; H04B 7/26; G08G 1/09; H04W 40/20

(52) U.S. Cl. CPC H04W 4/46; H04W 40/20; G08G 1/09; H04B 7/26

(57) ABSTRACT

This control device can suppress decreases in communication speed. The control device is provided with: a determination unit which determines whether or not a peripheral vehicle positioned in the periphery of a first vehicle is traveling on the same travel road as the first vehicle; a relay vehicle selection unit which, in inter-vehicle communication for communicating between vehicles, selects, as a second vehicle for relaying data from the first vehicle, one of the peripheral vehicles determined by the determination unit to be traveling on the same travel road as the first vehicle; and an inter-vehicle communication control execution unit which executes control for the inter-vehicle communication unit of the first vehicle to allow inter-vehicle communication with the second vehicle.

### TECHNICAL FIELD

The present disclosure relates to a control apparatus and a vehicle.

### BACKGROUND ART

A vehicle-to-vehicle communication system has been known, in which communication is performed among vehicles by relaying data among a plurality of vehicles, for example.

### CITATION LIST

### Patent Literature

### PTL 1

### Japanese Patent Application Laid-Open No. 2004-80383

### SUMMARY OF INVENTION

### Technical Problem

Meanwhile, in places where a plurality of roads cross each other or run in parallel, there may be many vehicles that relay data. Consequently, data may be congested and cannot be transmitted and received smoothly when communication is performed between vehicles, and thus, a communication speed may be reduced.

An object of the present disclosure is to provide a control apparatus and a vehicle capable of suppressing reduction in a communication speed.

### Solution to Problem

To achieve the above-mentioned object, a control apparatus according to the present disclosure includes:

a determination section that determines whether a surrounding vehicle positioned around a first vehicle travels on a same travel road as the first vehicle;

a relay vehicle selection section that selects, among a plurality of the surrounding vehicles, a vehicle which is determined by the determination section to be traveling on the same travel road as the first vehicle, as a second vehicle that relays data from the first vehicle in vehicle-to-vehicle communication in which communication between vehicles is performed; and

a vehicle-to-vehicle communication control execution section that executes control for vehicle-to-vehicle communication section of the first vehicle to perform vehicle-to-vehicle communication with the second vehicle

A vehicle according to the present disclosure includes:

the control apparatus.

### Advantageous Effects of Invention

The present disclosure can suppress reduction in a communication speed.

### BRIEF DESCRIPTION OF DRAWINGS

FIG. 1 is a block diagram schematically illustrating a configuration of a vehicle control apparatus according to an embodiment of the present disclosure;

FIG. 2 schematically illustrates a first vehicle and surrounding vehicles positioned around the first vehicle in a grade separated junction of freeway and general road; and

FIG. 3 is a flowchart illustrating an exemplary processing operation of the vehicle control apparatus according to the embodiment.

### DESCRIPTION OF EMBODIMENTS

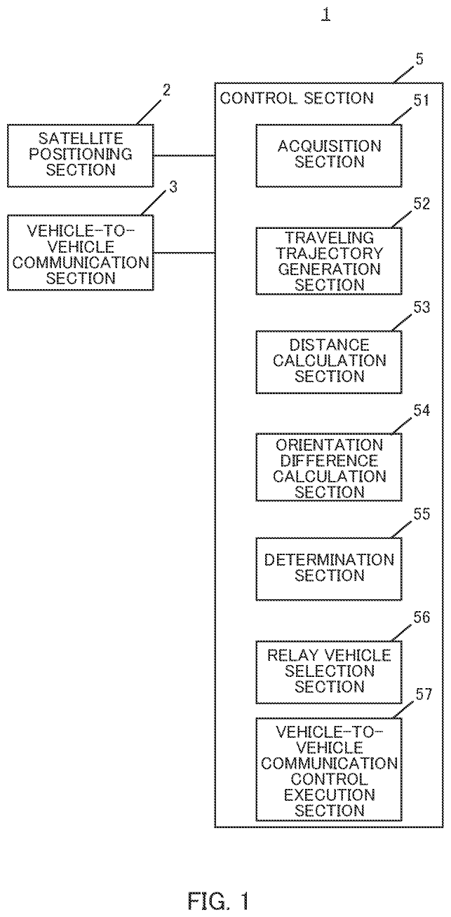

Hereinafter, an embodiment of the present disclosure will be described in detail with reference to the drawings. FIG. 1 is a block diagram schematically illustrating a configuration of vehicle control apparatus 1 according to the embodiment of the present disclosure. Vehicle control apparatus 1 includes satellite positioning section 2, vehicle-to-vehicle communication section 3, and control section 5. Vehicle control apparatus 1 is installed in each vehicle. Hereinafter, vehicle control apparatus 1 will be described as being installed in the first vehicle.

Satellite positioning section 2 measures a position (longitude, latitude, and altitude) of the vehicle. For example, a publicly known Global Positioning System (GPS) is used for satellite positioning section 2. Note that, information on the vehicle position to be measured by satellite positioning section 2 includes information on a vehicle orientation.

Vehicle-to-vehicle communication section 3 is a communication device that performs transmission and reception between vehicles, using a radio wave of a predetermined frequency band, and vehicle-to-vehicle communication section 3 exchanges various kinds of information on vehicles between vehicles. The various kinds of information on vehicles herein includes information on the vehicle position (longitude, latitude, and altitude) measured by satellite positioning section 2 and measurement accuracy of the vehicle position.

Control section 5 is configured of a microcomputer including a Central Processing Unit (CPU), Read Only Memory (ROM), Random Access Memory (RAM), an input interface, and an output interface. The CPU reads out programs corresponding to processing from ROM, loads the programs into RAM, and centrally controls operations of respective blocks, cooperating with the loaded programs. In the present embodiment, control section 5 has functions as acquisition section 51, traveling trajectory generation section 52, distance calculation section 53, orientation difference calculation section 54, determination section 55, relay vehicle selection section 56, and vehicle-to-vehicle communication control execution section 57. Note that, these functions may be included in an Electric Control Unit (ECU), which is a device that controls respective systems of the vehicle by using an electronic circuit. Meanwhile, any part or all of these functions may be provided separately from the ECU.

Acquisition section 51 acquires position information on the first vehicle from satellite positioning section 2. In addition, acquisition section 51 also acquires position information on a surrounding vehicle transmitted from one or more surrounding vehicles positioned around the first vehicle via vehicle-to-vehicle communication section 3.

Incidentally, a method has been known, which relays communication data by vehicle-to-vehicle communication section 3 installed in a surrounding vehicle while using a surrounding vehicle positioned around the first vehicle for relaying (referred to as “hopping”).

In one example, an approach signal notifying an approach of an emergency vehicle is transmitted from the first vehicle to a preceding surrounding vehicle. The preceding surrounding vehicle that has received the approach signal further transmits the approach signal to a vehicle traveling ahead of the preceding surrounding vehicle.

Further, for example, an approach signal notifying an approach of a place where a traffic accident has occurred is transmitted from the first vehicle to a following surrounding vehicle. The following surrounding vehicle that has received the approach signal further transmits the approach signal to a vehicle traveling behind of the following surrounding vehicle.

However, when there are many surrounding vehicles around the first vehicle, for example, in places where a plurality of roads cross each other, data transmitted from the first vehicle may be congested and cannot be transmitted and received smoothly when vehicle-to-vehicle communication is performed, which may reduce a communication speed. The reduction in a communication speed may cause the first vehicle to fail in transmitting the approach signal to the surrounding vehicle.

In order to surely transmit the approach signal from the first vehicle to the surrounding vehicle, it is necessary to select a second vehicle that relays the data from the first vehicle in vehicle-to-vehicle communication and to relay communication data, using the selected second vehicle.

In the following description, one of the first vehicle and the surrounding vehicle is assumed to as a preceding vehicle and the other one of the first vehicle and the surrounding vehicle is assumed to be a following vehicle.

In the present embodiment, traveling trajectory generation section 52 generates a traveling trajectory of the preceding vehicle on a virtual plane based on a time series of position information on the preceding vehicle acquired by acquisition section 51.

Distance calculation section 53 calculates a distance between the traveling trajectory of the preceding vehicle generated by traveling trajectory generation section 52 and a present position information on the following vehicle acquired by acquisition section 51. Specifically, distance calculation section 53 calculates the length of a perpendicular line drawn from the present position information on the following vehicle to the traveling trajectory of the preceding vehicle.

Orientation difference calculation section 54 calculates an orientation difference between an orientation of the traveling trajectory at an intersection of the traveling trajectory of the preceding vehicle and the perpendicular line, and a present orientation (traveling direction) of the following vehicle. Note that, the position information on a vehicle to be measured by satellite positioning section 2 includes information on a vehicle orientation.

Incidentally, when the measurement accuracy of the positions of surrounding vehicles is low due to various factors, an error between the measured position information on a surrounding vehicle and an actual position information on the surrounding vehicle becomes large, and thus, the traveling trajectory to be generated by traveling trajectory generation section 52 significantly deviates from an actual traveling trajectory. Consequently, the distance calculated by distance calculation section 53 may be significantly different from an actual distance. Further, the orientation difference calculated by orientation difference calculation section 54 may also significantly deviate from an actual orientation difference. As a result, determination section 55 may erroneously determine whether the surrounding vehicle travels on the same travel road as the first vehicle. Note that, in the present embodiment, a criterion for determining that the travel roads are the same is whether at least a part of the traveling trajectories generated by illustrating passing points of vehicles on the virtual plane overlaps, not whether the roads in a map data are the same.

Then, in the present embodiment, when the measurement accuracy of the positions of surrounding vehicles is not less than a predetermined value, traveling trajectory generation section 52 generates the traveling trajectory, distance calculation section 53 calculates the distance, and orientation difference calculation section 54 calculates the orientation difference. Determination section 55 determines whether the surrounding vehicle travels on the same travel road as the first vehicle, based on the calculated distance and the calculated orientation difference.

On the other hand, when the measurement accuracy of the positions of surrounding vehicles is less than a predetermined value, traveling trajectory generation section 52 does not generate the traveling trajectory, distance calculation section 53 does not calculate the distance, and orientation difference calculation section 54 does not calculate the orientation difference. Accordingly, determination section 55 does not determine whether the surrounding vehicle travels on the same travel road as the first vehicle.

Determination section 55 determines that the following vehicle travels on the same travel road as the preceding vehicle in a case where the distance calculated by distance calculation section 53 is not greater than a predetermined distance, and the orientation difference calculated by orientation difference calculation section 54 is not greater than a predetermined angle either. In the following description, “traveling on the same travel road” means that the following vehicle travels on the same travel road as the preceding vehicle travels, and that the preceding vehicle has traveled on the same travel road as the following vehicle has traveled

Relay vehicle selection section 56, among the surrounding vehicles, selects a vehicle (the other one of the preceding vehicle and the following vehicle) determined by determination section 55 to be traveling the same travel road as the first vehicle (one of the preceding vehicle and the following vehicle) as the second vehicle that relays the data from the first vehicle in inter-vehicle communication.

Vehicle-to-vehicle communication control execution section 57 executes control for vehicle-to-vehicle communication section 3 to perform vehicle-to-vehicle communication with the second vehicle. Thus, for example, the second vehicle is notified that it has been selected as a vehicle that relays the data from the first vehicle.

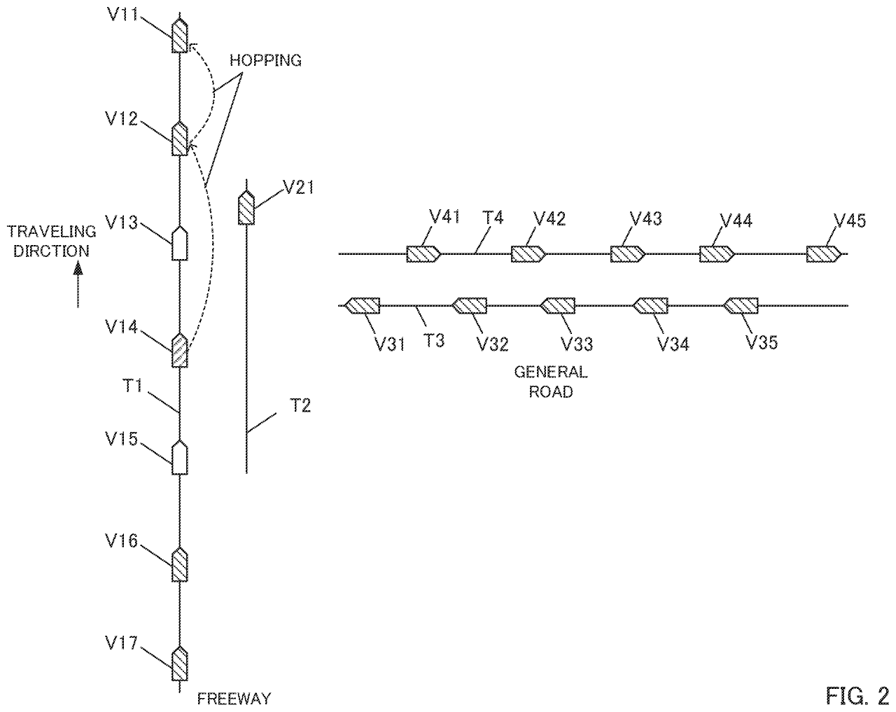

Next, a concrete example of vehicle control apparatus 1 will be described with reference to FIG. 2. FIG. 2 schematically illustrates a first vehicle and a plurality of surrounding vehicles in a grade separated junction of freeway and general road. Note that, a traveling trajectory will be generated for each vehicle; however, for simplicity of description, traveling trajectory T1 of first vehicle V14, surrounding vehicles V11, V12, V13, V15, V16, and V17 is assumed to be the same as each other. Traveling trajectory T2 of surrounding vehicle V21 is assumed to be different from traveling trajectory T1. Traveling trajectory T3 of surrounding vehicles V31, V32, V33, V34, and V35 is assumed to be the same as each other and different from traveling trajectory T1. Further, traveling trajectory T4 of surrounding vehicles V41, V42, V43, V44, and V45 is assumed to be the same as each other and different from traveling trajectory T1.

In the following description, a traveling direction of a vehicle may be referred to as “ahead” or “forward direction”, and surrounding vehicles V11, V12, and V13 that precede first vehicle V14 may be each referred to as a “preceding vehicle”. Here, first vehicle V14 will be described as an emergency vehicle.

[Surrounding Vehicle V11]

Acquisition section 51 of first vehicle V14 acquires position information on first vehicle V14 measured by satellite positioning section 2. Acquisition section 51 of first vehicle V14 also acquires position information on surrounding vehicle V11 received from vehicle-to-vehicle communication section 3. Note that, measurement information on the position of surrounding vehicle V11 is assumed to be not less than a specified value.

When measurement accuracy of the position of surrounding vehicle V11 is not less than the specified value, control section 5 of first vehicle V14 executes control of second vehicle selection processing.

Traveling trajectory generation section 52 of first vehicle V14 generates traveling trajectory T1 (see FIG. 2) of surrounding vehicle V11 on a virtual plane based on a time series of position information on surrounding vehicle V11.

Distance calculation section 53 of first vehicle V14 calculates a distance between traveling trajectory T1 of surrounding vehicle V11 and the present position information on first vehicle V14.

Orientation difference calculation section 54 of first vehicle V14 calculates an orientation difference between an orientation of traveling trajectory T1 of surrounding vehicle V11 and the present orientation of first vehicle V14.

Determination section 55 of first vehicle V14 determines that surrounding vehicle V11 travels on the same travel road as first vehicle V14 in a case where the distance calculated by distance calculation section 53 is not greater than the predetermined distance, and the orientation difference calculated by orientation difference calculation section 54 is not greater than the predetermined angle either.

When surrounding vehicle V11 is determined to be traveling on the same travel road as first vehicle V14 by determination section 55, relay vehicle selection section 56 of first vehicle V14 selects surrounding vehicle V11 as the second vehicle that relays the data from first vehicle V14 in inter-vehicle communication.

[Surrounding Vehicle V12]

Here, measurement information on the position of surrounding vehicle V12 is assumed to be not less than a specified value. Traveling trajectory generation section 52 of first vehicle V14 generates traveling trajectory T1 (see FIG. 2) of surrounding vehicle V12 on a virtual plane based on a time series of position information on surrounding vehicle V12. Distance calculation section 53 of first vehicle V14 calculates a distance between traveling trajectory T1 of surrounding vehicle V12 and the present position information on first vehicle V14. Orientation difference calculation section 54 of first vehicle V14 calculates an orientation difference between an orientation of traveling trajectory T1 of surrounding vehicle V12 and the present orientation of first vehicle V14.

Determination section 55 of first vehicle V14 determines that surrounding vehicle V12 travels on the same travel road as first vehicle V14 in a case where the distance calculated by distance calculation section 53 is not greater than the predetermined distance, and the orientation difference calculated by orientation difference calculation section 54 is not greater than the predetermined angle either. When surrounding vehicle V12 is determined to be traveling on the same travel road as first vehicle V14 by determination section 55, relay vehicle selection section 56 of first vehicle V14 selects surrounding vehicle V12 as the second vehicle that relays the data from first vehicle V14 in inter-vehicle communication.

[Surrounding Vehicle V13]

Here, measurement information on the position of surrounding vehicle V13 is assumed to be less than a specified value. When measurement accuracy of the position of surrounding vehicle V13 is less than a specified value, control section 5 first vehicle V14 does not execute control of second vehicle selection processing. Thus, surrounding vehicle V13 is not selected as the second vehicle.

[Surrounding Vehicles V15, V16, and V17]

In a case where it is assumed that first vehicle V14 is an emergency vehicle, and an approach signal is notified to a preceding vehicle of first vehicle V14, surrounding vehicles V15, V16, and V17, that is, following vehicles of first vehicle V14, are not selected as second vehicles.

[Surrounding Vehicle V21]

For surrounding vehicle V21, processing similar to the second vehicle selection processing in surrounding vehicle V11 is executed. In this case, the travel road of surrounding vehicle V21 (traveling trajectory T2) is different from the travel road of first vehicle V14 (traveling trajectory T1), so that surrounding vehicle V21 is not selected as the second vehicle.

[Surrounding Vehicles V31 and the Like]

For surrounding vehicles V31, V32, V33, V34, and V35, processing similar to second vehicle selection processing in surrounding vehicle V11 is executed. In this case, the travel road of surrounding vehicles V31, V32, V33, V34, and V35 (traveling trajectory T3) is different from the travel road of first vehicle V14 (traveling trajectory T1), so that surrounding vehicles V31, V32, V33, V34, and V35 are not selected as the second vehicle.

[Surrounding Vehicles V41 and the Like]

For surrounding vehicles V41, V42, V43, V44, and V45, processing similar to second vehicle selection processing in surrounding vehicle V11 is executed. In this case, the travel road of surrounding vehicles V41, V42, V43, V44, and V45 (traveling trajectory T4) is different from the travel road of first vehicle V14 (traveling trajectory T1), so that surrounding vehicles V41, V42, V43, V44, and V45 are not selected as the second vehicle.

Thus, in a case where first vehicle V14 is assumed to be an emergency vehicle, the second vehicle that relays the approach signal notifying an approach of the emergency vehicle is limited to surrounding vehicles V11 and V12. For example, first vehicle V14 notifies surrounding vehicles V11 and V12 of being selected as the second vehicle. When receiving data from first vehicle V14, surrounding vehicles V11 and V12 determine whether to relay the received data, in accordance with the notification.

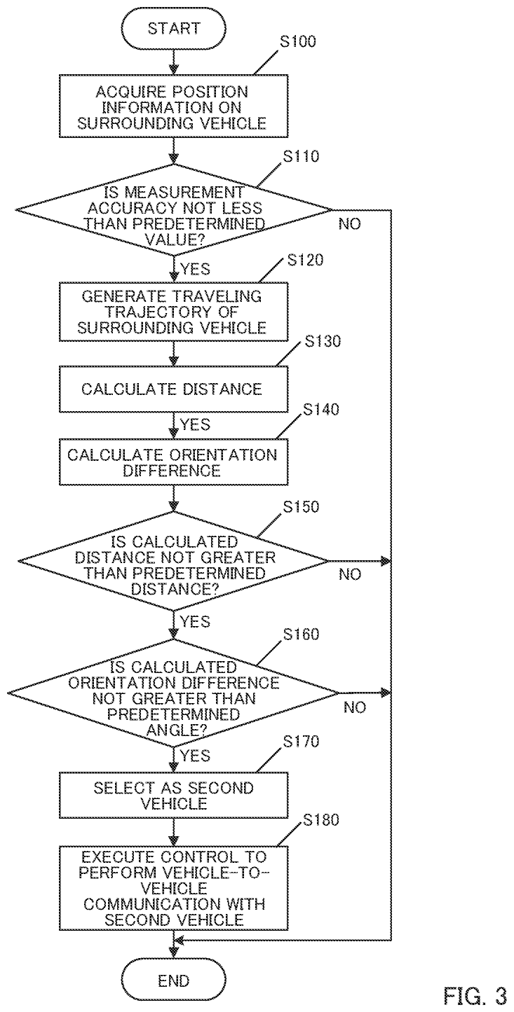

Next, a description will be given of a processing operation of vehicle control apparatus 1 according to the embodiment with reference to FIG. 3. FIG. 3 is a flowchart illustrating an exemplary processing operation of vehicle control apparatus 1 according to the embodiment. The flow is appropriately started during traveling of a vehicle.

First, in step S100, acquisition section 51 acquires position information on a surrounding vehicle positioned around the first vehicle.

Then, in step S110, determination section 55 determines whether the measurement accuracy of the position of the surrounding vehicle is not less than the specified value. When the measurement accuracy of the position of the surrounding vehicle is not less than the specified value (step S110: YES), the processing proceeds to step S120. When the measurement accuracy of the position of the surrounding vehicle is less than the specified value (step S110: NO), the processing ends.

In step S120, traveling trajectory generation section 52 generates a traveling trajectory on the surrounding vehicle based on the position information on the surrounding vehicle.

Then, in step S130, distance calculation section 53 calculates a distance between the traveling trajectory of the surrounding vehicle and the present position information on the first vehicle.

Then, in step S140, orientation difference calculation section 54 calculates an orientation difference between an orientation of the traveling trajectory of the surrounding vehicle and the present orientation of the first vehicle.

Then, in step S150, determination section 55 determines whether the distance calculated by distance calculation section 53 is not greater than the predetermined distance. When the distance is not greater than the predetermined distance (step S150: YES), the processing proceeds to step S160. When the distance is greater than the predetermined distance (step S150: NO), the processing ends.

In step S160, determination section 55 determines whether the orientation difference calculated by orientation difference calculation section 54 is not greater than the predetermined angle. When the orientation difference is not greater than the predetermined angle (step S160: YES), the processing proceeds to step S170. When the orientation difference is greater than the predetermined angle (step S160: NO), the processing ends.

In step S170, relay vehicle selection section 56 selects the surrounding vehicle as the second vehicle that relays the data from the first vehicle in inter-vehicle communication.

In step S180, vehicle-to-vehicle communication control execution section 57 executes control for vehicle-to-vehicle communication section 3 to perform vehicle-to-vehicle communication with the second vehicle.

Vehicle control apparatus 1 according to the above embodiment includes: determination section 55 that determines whether a surrounding vehicle positioned around a first vehicle travels on a same travel road as the first vehicle; and relay vehicle selection section 56 that selects, among a plurality of the surrounding vehicles, a vehicle which is determined by determination section 55 to be traveling on the same travel road as the first vehicle, as a second vehicle that relays data from the first vehicle in vehicle-to-vehicle communication in which communication between vehicles is performed. Thus, even when there are many surrounding vehicles around the first vehicle, it is possible to specify a surrounding vehicle as the second vehicle. This enables smoothly transmitting and receiving the data from the first vehicle without congestion in vehicle-to-vehicle communication, and thus, the reduction in a communication speed can be suppressed.

In addition, determination section 55 determines whether the surrounding vehicle travels on the same travel road as the first vehicle based on the distance between the traveling trajectory of the surrounding vehicle and the present position information on the first vehicle and the orientation difference between the orientation of the traveling trajectory of the surrounding vehicle and the present orientation of the first vehicle. This enables determining whether the surrounding vehicle travels on the same travel road as the first vehicle without using map data.

Further, control section 5 does not execute control of second vehicle selection processing when the measurement accuracy of the position of the surrounding vehicle is less than the specified value. This reduces an error in selecting the second vehicle, and thereby, the data from the first vehicle can be smoothly relayed.

Besides, determination section 55 determines whether the surrounding vehicle travels on the same travel road as the first vehicle based on the orientation difference between the orientation of the traveling trajectory of the preceding vehicle and the present orientation of the following vehicle. This also reduces an error in selecting the second vehicle, and thereby, the data from the first vehicle can be smoothly relayed.

In the above embodiment, relay vehicle selection section 56 may select, for example, surrounding vehicle V21 that travels on traveling trajectory T2 illustrated in FIG. 2, as the second vehicle. In this case, relay vehicle selection section 56 selects, as the second vehicle, surrounding vehicle V11 and/or the like that travels on the lane as traveling trajectory T1 on which first vehicle V14 travels in preference to surrounding vehicle V21 that travels on the adjacent lane as traveling trajectory T2. Thus, for example, when the number of surrounding vehicles that travel on a lane as the second vehicle is small, the surrounding vehicle that travels on a lane adjacent to the lane is selected as the second vehicle, which enables smoothly transmitting and receiving the data from the first vehicle in vehicle-to-vehicle communication.

In the above embodiment, satellite positioning section 2 is used as a positioning device that measures the position of the vehicle; however, the positioning device is not limited to satellite positioning section 2, may be a device that performs measuring from data obtained by a vehicle speed sensor, a yaw rate sensor, or a steering angle sensor, using what is called autonomous navigation system, and/or may be a device that uses a beacon and/or the like.

In the above embodiment, selection of the second vehicle that relays the data from the first vehicle is performed for each vehicle; however, the selection may be performed for each vehicle group of platooning vehicles.

The embodiments described above are merely examples of specific implementation of the present disclosure, and the technical scope of the present disclosure should not be restrictively interpreted by these embodiments. That is, the present disclosure may be implemented in various forms without departing from the spirit thereof or the major features thereof.

This application is based on Japanese Patent Application No. 2018-163362, filed on Aug. 31, 2018, the contents of which are incorporated herein by reference.

### INDUSTRIAL APPLICABILITY

The present disclosure is suitably used for a vehicle which includes a control apparatus that is required to suppress reduction in a communication speed.

### REFERENCE SIGNS LIST

1 Vehicle control apparatus
2 Satellite positioning section
3 Vehicle-to-vehicle communication section
5 Control section
51 Acquisition section
52 Traveling trajectory generation section
53 Distance calculation section
54 Orientation difference calculation section
55 Determination section
56 Relay vehicle selection section
57 Vehicle-to-vehicle communication control execution section

1. A control apparatus, comprising:
a determination section that determines whether a surrounding vehicle positioned around a first vehicle travels on a same travel road as the first vehicle;
a relay vehicle selection section that selects, among a plurality of the surrounding vehicles, a vehicle which is determined by the determination section to be traveling on the same travel road as the first vehicle, as a second vehicle that relays data from the first vehicle in vehicle-to-vehicle communication in which communication between vehicles is performed; and
a vehicle-to-vehicle communication control execution section that executes control for vehicle-to-vehicle communication section of the first vehicle to perform vehicle-to-vehicle communication with the second vehicle.

2. The control apparatus according to claim 1, wherein:
when a measurement accuracy of a position of the surrounding vehicle is not less than a specified value, the determination section determines whether the surrounding vehicle travels on a same travel road as the first vehicle.

3. The control apparatus according to claim 1, wherein:
the relay vehicle selection section selects a third vehicle that travels on a lane on which the first vehicle travels in preference to a fourth vehicle that travels on an adjacent lane adjacent to the lane, as the second vehicle.

4. The control apparatus according to claim 1, comprising:
an acquisition section that acquires position information on a preceding vehicle when one of the first vehicle and the surrounding vehicle is assumed to be the preceding vehicle and the other one of the first vehicle and the surrounding vehicle is assumed to be a following vehicle; and
a traveling trajectory generation section that generates a traveling trajectory of the preceding vehicle based on the position information on the preceding vehicle obtained by the acquisition section,
wherein, when a distance between the traveling trajectory of the preceding vehicle generated by the traveling trajectory generation section and present position information on the following vehicle acquired by the acquisition section is not greater than a predetermined distance, the determination section determines that the following vehicle is traveling on a same travel road as the preceding vehicle.

5. A vehicle, comprising the control apparatus according to claim 1.
